(19) United States
(12) Patent Application Publication
(10) Pub. No.: US 2024/0025242 A1
(43) Pub. Date: Jan. 25, 2024

(54) Wheel Rim Cover

(71) Applicant: Donald Lewis, Norfolk, VA (US)

(72) Inventor: Donald Lewis, Norfolk, VA (US)

(21) Appl. No.: 17/872,399

(22) Filed: Jul. 25, 2022

(51) Int. Cl. B60J 11/10

(52) U.S. Cl. CPC B60J 11/10

(57) ABSTRACT

The rim spray cover is the only product of its kind that has the capability of adjusting to the size of a particular rim to accommodate every vehicle make or model, offering reliability as an accessory for varying rim sizes. This unprecedented product is uniquely designed with high-quality, durable materials to ensure long-term sustainability and complete functionality, at all times.

### BACKGROUND

For those who like shiny tires after detailing their vehicles, re-cleaning wheels after spraying tire shine products on the material can be a labor intensive and time-consuming chore. This task becomes more challenging as the overspray from such products also land on brake parts and other surface areas of the rim, which often requires individuals to re-clean various parts of their automobiles.

There have been no products available as original equipment or as an aftermarket to address this problem.

An apparatus to prevent having to reclean various parts of the automobile while working on cleaning the rest of the vehicle is not being met by any known device or system at present. There have been no products available as original equipment or as an aftermarket to address this problem either.

### SUMMARY OF THE INVENTION

The main purpose of the wheel rim cover is to provide users with a protective rim cover for automobiles via an adjustable perimeter for shielding brake rotors and brake parts from detailing chemicals and abrasives.

A vehicle wheel cover comprises a wheel cover having a diameter equal to or larger than a rim diameter of the vehicle wheel and a gathered perimeter smaller than the diameter. The disclosure also includes a plurality of clips configured to secure the wheel cover at the gathered perimeter to a lip of the rim. The disclosure further includes a motion fold adjuster configured to expand the perimeter proximal the diameter to fit a plurality of vehicle wheels of a variety of rim diameters.

### BRIEF DESCRIPTION OF THE DRAWINGS

FIG. 1 is a left perspective view of the wheel rim cover in accordance with an embodiment of the present disclosure.

FIG. 2 is a bottom view of the unassembled wheel rim cover in accordance with an embodiment of the present disclosure.

FIG. 3 is a bottom view of an assembled wheel rim cover in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

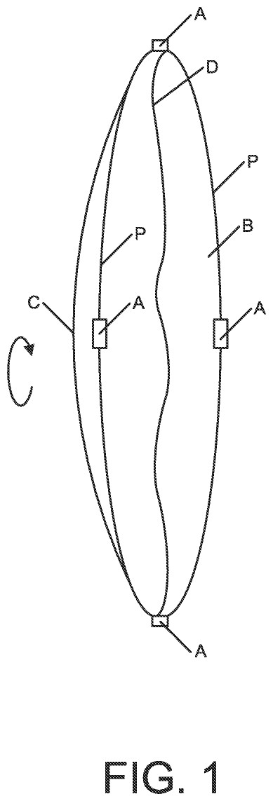

FIG. 1 is a left perspective view of the wheel rim cover showing: rim clips referenced as A, 24″ thin plastic rim cover and material referenced as B, inside perimeter referenced as C, motion fold or slit adjuster referenced as D and outside perimeter referenced as P in accordance with an embodiment of the present disclosure. The motion fold adjuster D is a type of a gather line in the material of the wheel rim cover B.

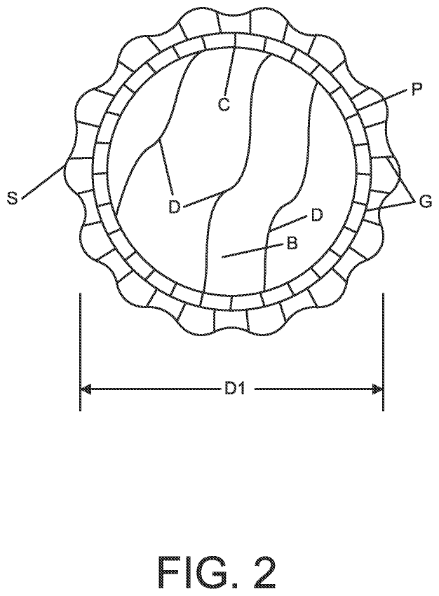

FIG. 2 is a bottom view of the unassembled wheel rim cover in accordance with an embodiment of the present disclosure. The view shows gather lines between the inside perimeter C and the outer perimeter P, the motion folds and gather lines G between the perimeters C and P and the slack material S. Some of the motion folds D and the gather lines G disappear when the wheel rim cover is assembled over a wheel rim and even more disappear when assembled over a larger wheel rim. Multiple motion fold adjuster lines D are present in the wheel rim cover B. The inside perimeter C and the outer perimeter P accommodate an elastic ring in embodiments of the present disclosure. The clips A (not shown) secure the outer perimeter P to the wheel rim lip despite an extra or gather material within the perimeter P but preserve the wheel rim diameter for detailing the tire attached to the wheel rim.

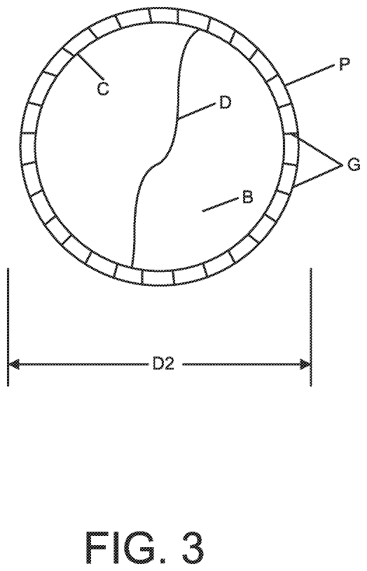

FIG. 3 is a bottom view of an assembled wheel rim cover in accordance with an embodiment of the present disclosure. Some of the motion fold adjuster lines D, and the gather lines G have disappeared from assembly over a large or larger wheel rim. The clips A (not shown) fasten the wheel rim cover B onto the wheel rim at the wheel rim lip despite the gathered or unused material in the folds over the wheel rim or proximal the perimeters C and P.

The present disclosed wheel rim cover, also known as the “Rim Spray Cover” offers a modern accessory that prevents tire shine protectant spray residue from sticking to wheels, calipers, brake discs, and the entire surface area of the rim, to allow for a more efficient and quicker car detailing process. Expanding on the initial design of an average vehicle, the rim spray cover introduces a novel handheld rim cover that adjusts to the size of the particular rim and adequately covers it as a user applies the product onto the tire. As a result, individuals will no longer have to re-clean their rims as the rim spray cover offers a shield that ensures all other components of the vehicle that otherwise would get dirties, are safeguarded, thereby, minimizing post-use clean-up responsibilities. This innovative, top-quality product ensures a fully operational vehicle accessory that enhances and improves any car detailing procedure.

Therefore, a purpose of the wheel rim cover is to provide users with a protective rim cover for automobiles similar to a hairnet with an adjustable perimeter for shielding brake rotors and brake parts from detailing chemicals and abrasives.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A vehicle wheel cover comprising:
a wheel cover having a diameter equal to or larger than a rim diameter of the vehicle wheel and a gathered perimeter smaller than the diameter;
a plurality of clips configured to secure the wheel cover at the gathered perimeter to a lip of the rim;
a motion fold adjuster configured to expand the perimeter proximal the diameter to fit a plurality of vehicle wheels of a variety of rim diameters.

2. The vehicle wheel cover of claim 1, wherein the plurality of clips comprise 5 clips corresponding to a number of lugs of the vehicle wheel.

3. The vehicle wheel cover of claim 1, wherein the wheel cover perimeter comprises an 18 inch diameter.

4. The vehicle wheel cover of claim 1, wherein the wheel cover perimeter comprises a 20 inch diameter.

5. The vehicle wheel cover of claim 1, wherein the wheel cover perimeter comprises a 22 inch diameter.

6. The vehicle wheel cover of claim 1, wherein the motion fold adjuster comprises a gathered material in multiple folds thereof over an elastic ring.

7. The vehicle wheel cover of claim 1, wherein the motion fold adjuster comprises a gathered material proximal an elastic ring embedded into a gathered material proximal thereto.

8. The vehicle wheel cover of claim 1, wherein the wheel cover comprises a fabric material.

9. The vehicle wheel cover of claim 1, wherein the wheel cover comprises a thin plastic material.

10. The vehicle wheel cover of claim 1, wherein the wheel cover comprises a washable fabric material.

11. The vehicle wheel cover of claim 1, wherein the clips are detachable from the wheel cover.

12. The vehicle wheel cover of claim 1, wherein the clips are attachable and detachable from the wheel cover.

13. The vehicle wheel cover of claim 1, wherein the clips are attached to the wheel cover proximal the motion fold adjuster.

14. The vehicle wheel cover of claim 1, wherein the clips are attached to the wheel cover distal to the motion fold adjuster.

15. The vehicle wheel cover of claim 1, wherein the motion fold adjuster comprises an inner perimeter and an outer perimeter.
